(19) United States
(12) Patent Application Publication
(10) Pub. No.: US 2005/0010909 A1
(43) Pub. Date: Jan. 13, 2005

(54) Non-intrusive testing method for real-time software

(76) Inventors: Pierre Lebee, Crepy-en-Valois (FR); Ivan Boule, Paris (FR)

Correspondence Address: HICKMAN PALERMO TRUONG & BECKER, LLP;AND SUN MICROSYSTEMS, INC., 1600 WILLOW STREET, SAN JOSE, CA, 95125, US

(21) Appl. No.: 10/626,419

(22) Filed: Jul. 23, 2003

(30) Foreign Application Priority Data
Jul. 23, 2002 (FR) 0209343

(51) Int. Cl. G06F 9/44; H04L 1/22; G06F 15/00; G06F 7/38

(52) U.S. Cl. 717/124; 714/38; 712/227; 712/244

(57) ABSTRACT

A method and system for managing data of a debug operation. A debugging system comprises a reserved memory comprising a plurality of portions of reserved memory, a mass memory, and a log management component for recording received data of a debug operation in at least one portion of the plurality of portions of the reserved memory. The log management component may also be configured for copying the data from at least a partially filled portion of the plurality of portions of the reserved memory to the mass memory in response to a drain condition, such that the data is copied to the mass memory in a non-intrusive manner.

### RELATED APPLICATION

This Application claims priority to the French Patent Application, Number 0209343, filed on Jul. 23, 2002, in the name of Sun Microsystems, Inc., which application is hereby incorporated by reference.

### FIELD OF INVENTION

Embodiments of the present invention pertain to the field of computer technology. More particularly, embodiments of the present invention pertain to methods and systems of debugging computer software.

### BACKGROUND OF THE INVENTION

Robust operating systems require debugging, for example, to detect execution problems of the operating systems or to improve configuration of the operating systems. Moreover, testing of applications is also required. In general, software applications and software tools require debugging methods.

Some testing methods exist which do not keep data of non-trivial problems occurring during and/or after execution, for example debugging methods which display data over a console and debugging methods which propose breakpoints. These current methods do not enable a user to analyze the data associated with non-trivial problems.

To keep data associated with non-trivial problems, a debugging method may require a substantial amount of memory. Moreover, testing real-time and asynchronous software is particularly complex because the debugging execution is generally not deterministic (e.g., time dependant). These aspects modify the behavior of the debugged operating system, applications or software tools. Thus, current debugging execution is very intrusive.

An external hardware technology, such as In Circuit Emulator (ICE) emulator technology, is known to be adapted to retrieve data on a bus, for example between a CPU and a memory, such data corresponding to the execution of operations. This hardware technology is thus non-intrusive. However, the emulator may not retrieve such data in the order of the execution of the operations. Moreover, some data corresponding to the execution of operations is not communicated through the bus but stays in the computer processing unit (CPU), for example in a register of the CPU. Thus, current hardware technology is problematic, as it does not enable a user to access to all data corresponding to the execution of operations and to analyze the retrieved data. Detection of debugging problems is thus not possible for robust operating systems.

### SUMMARY OF THE INVENTION

Embodiments of the present invention provide a debugging system intended to receive data of a debug operation. In one embodiment, the debugging system comprises a reserved memory comprising a plurality of portions of reserved memory, a mass memory, and a log management component for recording received data of a debug operation in at least one portion of the plurality of portions of the reserved memory. In one embodiment, the log management component is also configured for copying the data from at least a partially filled portion of the plurality of portions of the reserved memory to the mass memory in response to a drain condition, such that the data is copied to the mass memory in a non-intrusive manner.

Other embodiments of the present invention provide a method of managing data of a debug operation. A memory comprising a plurality of memory portions is reserved. Data of a debug operation is received. The data is recorded in at least one portion of the plurality of memory portions. In one embodiment, if the plurality of memory portions comprise data, a particular portion of plurality of memory portions is designated for recording subsequent data. In one embodiment, responsive to drain conditions, the data is copied from at least a partially filled portion of the plurality of memory portions to a mass memory.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a general diagram of a computer system upon which embodiments of the present invention may be practiced.

FIG. 2 shows a diagram of a portion of the computer system in accordance with an embodiment of the present invention.

FIG. 3 is a view of a portion of a working memory in accordance with an embodiment of the present invention.

FIG. 4 is a view of the portion of the working memory in an operation of a record method in accordance with an embodiment of the present invention.

FIG. 5 is another view of the working memory in another operation of the record method in accordance with another embodiment of the present invention.

FIG. 6 is another view of the working memory in another operation of the record method in accordance with another embodiment of the present invention.

FIG. 7 is a flow chart of the record only method in accordance with an embodiment of the present invention.

FIG. 8 is a flow chart of the record method of a record and drain method in accordance with an embodiment of the present invention.

FIG. 9 is a flow chart of the drain method of a record and drain method in accordance with an embodiment of the present invention.

### DETAILED DESCRIPTION

As they may be cited in this specification, Sun, Sun Microsystems, Solaris, ChorusOS are trademarks of Sun Microsystems, Inc. SPARC is a trademark of SPARC International, Inc.

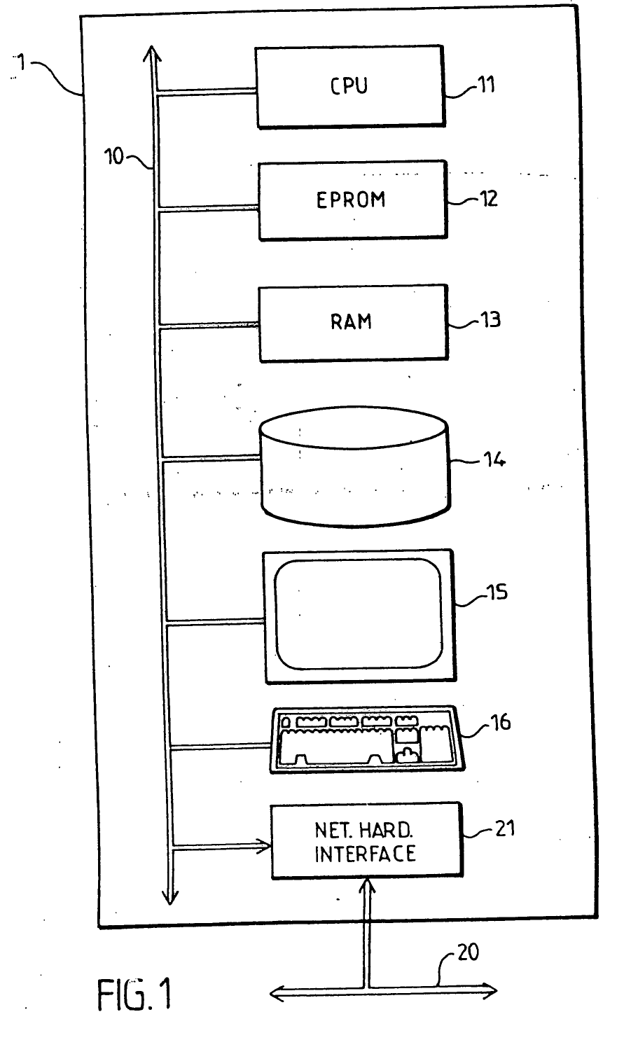

With reference to FIG. 1, embodiments of the present invention may be implemented in a computer system, or in a network comprising computer systems. The hardware of such a computer system 1 is for example as shown in FIG. 1. Computer system 1 comprises bus 10, processor 11 (e.g., an Ultra-Sparc) coupled to bus 10, program memory 12 (e.g. an EPROM for BIOS, a RAM, or Flash memory, or any other suitable type of memory) coupled to bus 10, working memory 13 (e.g. a RAM of any suitable technology, such as SDRAM coupled to bus 10, and mass memory 14 (e.g. one or more hard disks) coupled to bus 10. Computer system 1 also optionally comprises display 15 (e.g. a monitor) coupled to bus 10, user input device 16 (e.g. a keyboard and/or mouse) coupled to bus 10 and network interface device 21 coupled to bus 10 and to communication medium 20. Communication medium 20 may be in communication with other computer systems. Network interface device 21 may be for example, an Ethernet device, a serial line device, or an Asynchronous Transfer Mode (ATM) device. Communication medium 20 may be based, for example, on wire cables, fiber optics, or radio-communications.

Data may be exchanged between the components of computer system 1 through bus 10, schematically shown as a single bus for simplification of the drawing. However, it should be appreciated that bus 10 may comprise more than one bus. As is known, for example, bus systems may often include a processor bus (e.g. a PCI bus) connected via appropriate bridges to a device bus (e.g. an ISA bus or a SCSI bus).

For purposes of clarity in the following description, to reserve memory means to pre-allocate memory for a particular purpose.

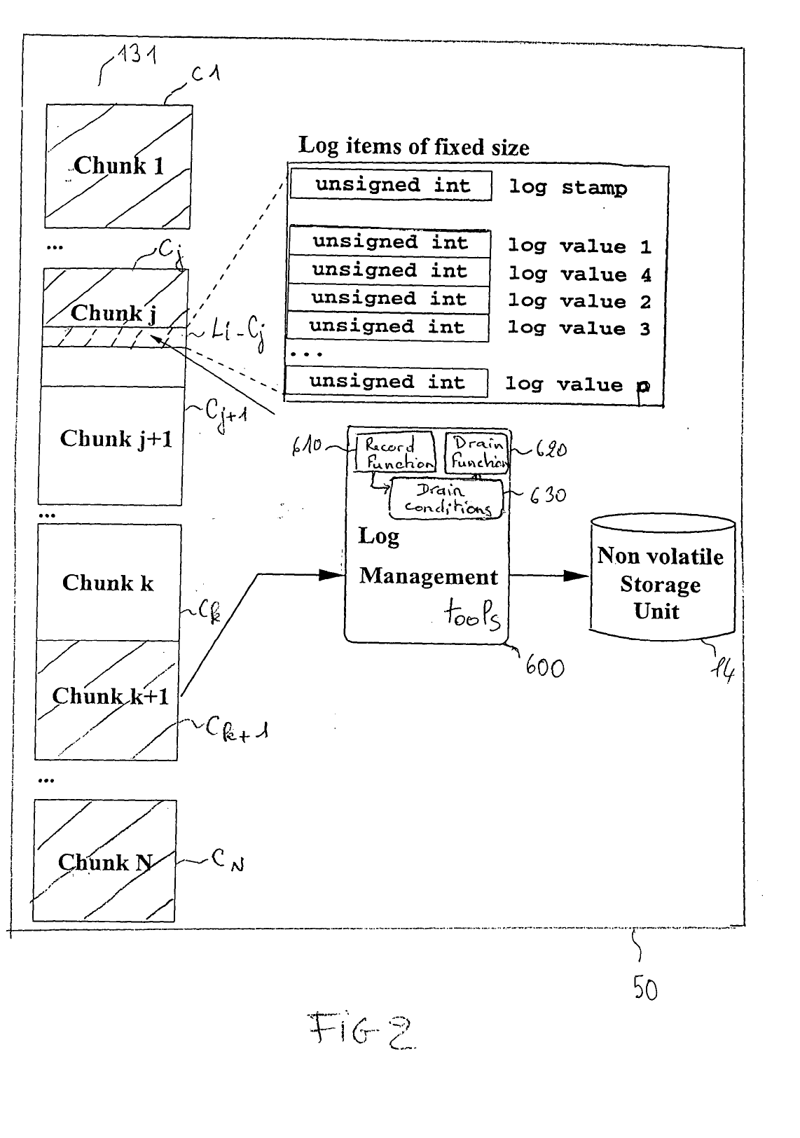

The following description pertains to FIGS. 2 and 3. FIG. 2 shows a diagram of a portion of computer system 1 of FIG. 1. Log system 50 comprises a portion of working memory 131, a log management component 600 and a non-volatile storage unit 14. The portion of working memory 131, also called a log and comprised in the RAM 13, is divided in N portions of memory, as chunk 1 (C₁) to chunk N(C_{N}), where N is a positive integer greater than one. A log is a fixed size record containing unsigned integers.

FIG. 3 is a diagram of a log in accordance with an embodiment of the present invention. Each chunk C₁ through C₈ is divided in M sub-portions of memory called log items, where M is a positive integer greater than one. As shown, chunk C₈ is divided into M log items from L₁-C₈ to L_{M}-C₈. In general, chunk Cⱼ comprises log item i designated as Lᵢ-Cⱼ in FIG. 3. A log item may also be a portion of memory. In one embodiment, each log item comprises a log stamp, being an unsigned integer, to designate a number incremented at each record of the log item. In another embodiment, each log item comprises a series of p log values, which may be unsigned integers, p being an integer. This integer p may be fixed by a user and may provide a fixed size for the log item.

At least one log is reserved before the start of a debugging method. This log comprises several chunks, each chunk being divided into several log items. In each log item, the log management component is adapted to store debugging data, where the debugging data is stored in the series of log values. With reference to FIG. 2, log management component 600 comprises record function 610 to record debugging data in log items and drain function 620 to copy debugging data from log items to the non-volatile storage unit 14, also referred to as a mass memory. As described hereinafter, drain function 620 may be started or its execution may continue if drain conditions 630 are satisfied. To start drain function 620, drain conditions 630 may comprise a request of the user to use drain function 620. Drain conditions 630 may define a variable that indicates whether or not drain function 620 is required. As seen hereinafter, drain conditions 630 may also comprise other conditions.

In the following description, data is considered to be debugging data, for example data concerning information which may be considered as useful to debug a program, such as a program of an operating system. A programmer may choose to retrieve debugging data by inserting instructions.

A log item may be in different states:
“Available to store data” if no data has been stored (or recorded) in the log item or if data stored in the log item has been copied (or transferred) from the log item, also called a data transfer in the following description.
“Filled with data” if data has been stored in the log item.

A chunk may also be in different states:
“Available to store data” if no data has been stored (or recorded) in the chunk or if data stored in the chunk has been copied (or transferred) from the chunk, also called a data transfer in the following description.
“Filled with data” if data has been stored in the chunk. For a chunk, “Filled with data” comprises “completely filled with data” if all log items of the chunk are filled with data and “partially filled with data” if some log items of the chunk are filled with data.

A log may also be “completely filled with data” or “partially filled with data”.

With reference to FIG. 2, cross-hatched in solid lines chunks as C₁, Cₖ₊₁, and C_{N} designate chunks having log items filled with data. Cⱼ is comprised of different log items: cross-hatched log items are filled with data, the cross-hatched in dotted lines log item Lᵢ-Cⱼ represents a log item in a data record phase, other non cross-hatched log items represent log items available to store data and thus available for a data record phase. Other non cross-hatched chunks as Cⱼ₊₁ to Cₖ represent chunks available to store data.

The log is linked to log management component 600 adapted to manage a record method in the log. Two methods of data management are described herein, wherein a variable called a flag designates the chosen method (e.g. chosen by a user). The first method is designated as a “record only method” and the second method is designated as a “record and drain method”. In the record and drain method, log management component 600 is adapted to manage a data transfer method from the log to the non-volatile storage unit 14 (e.g. a hard disk).

FIG. 3 illustrates a log at the initialization time before recording data in the log. In other words, all log items are available to store data.

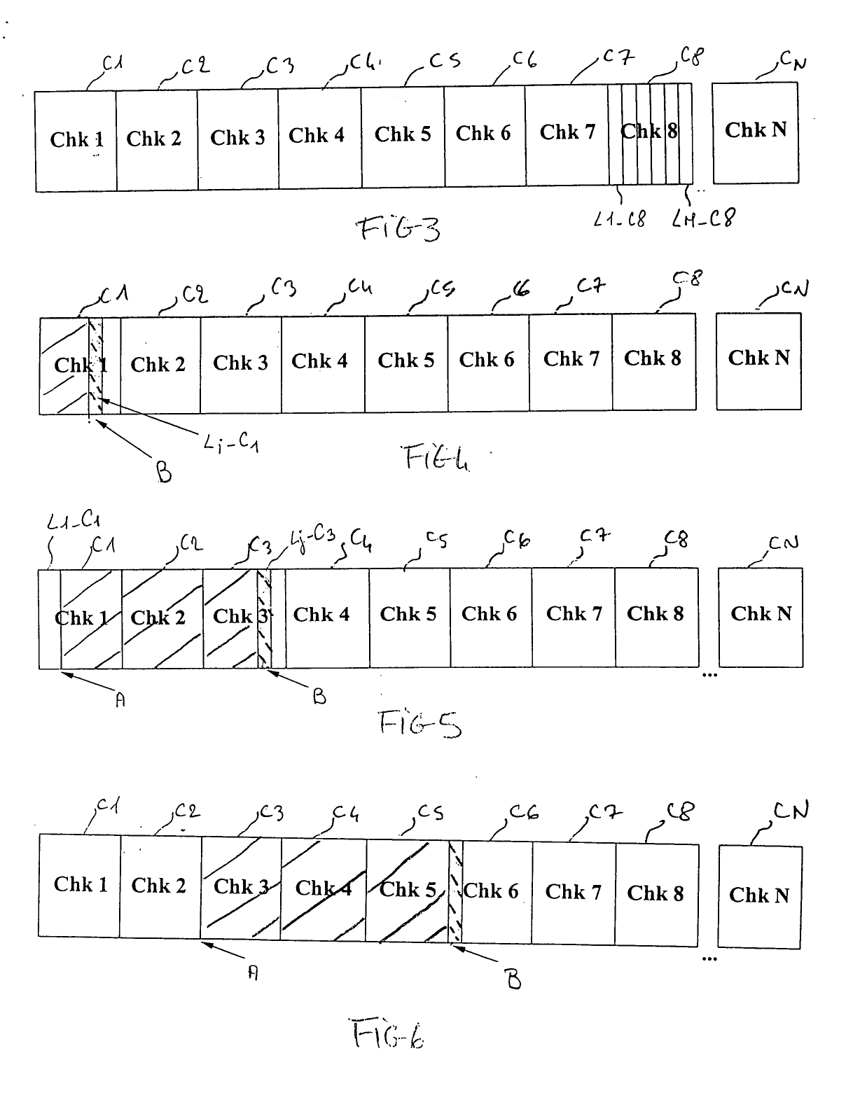

FIG. 4 illustrates an instant of data recording according to the “record only method” or the “record and drain method” in accordance with embodiments of the present invention.

With reference to FIG. 4, the log comprises N chunks C₁ to C_{N}. At the beginning of an application, as shown in FIG. 3, all the chunks are available to store data. The log management component (e.g., log management component 600 of FIG. 2) is adapted to store data in the log according to the operations of a record method. The log management component stores first data in the log items of the chunk C₁. Arrow B designates the log item in a data record phase. In FIG. 4, arrow B corresponds to the log item Lᵢ-C₁ in a data record phase. In the record only method, the entire log is filled with data, and arrow B designates the limit between a first part of the log being filled with data and a second part of the log being available to store data. In the record and drain method, arrow B designates the front end of the portion of the log containing log items filled with data. A portion of the log designates a given number of chunks.

In the record only method, the log management component stores data in the successive log items of the chunks C₁ to C_{N}. Once the log is completely filled with data, the record only method enables the reuse of a log item of a chunk in order to record next arriving data. The next log item to be reused, and thus erased, is the log item having the oldest recorded data. In one embodiment, in which data is recorded in consecutive log items, the oldest recorded data is in L₁-C₁ when the log is completely filled and is a circular buffer. Then, the oldest recorded data is in the next consecutive log item as the log operates as a circular buffer.

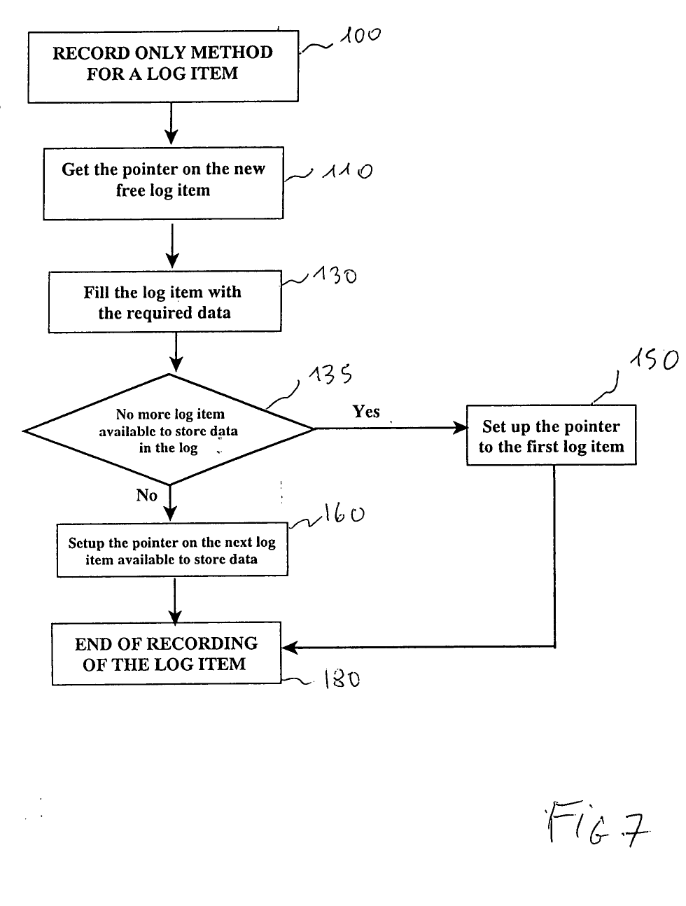

FIGS. 5 and 6 illustrate different instants of a data record method of the record and drain method according to embodiments of the present invention. With reference to FIG. 5, the log management component stores data in the successive log items of the chunks C₁ to C₃. In other words, when the first chunk (e.g., C₁) is completely filled with data, the log management component stores data in the second chunk (e.g., C₂). Arrow B corresponds to the log item Lⱼ-C₃ in a data record phase. The log management component is also adapted to transfer data of log items in the non-volatile storage unit. Arrow A designates the limit between a log item whose data has just been transferred in the non-volatile storage unit and log items filled with data. Thus, log items filled with data are limited at a first extremity by arrow A and at the other extremity by arrow B.

With reference to FIG. 6, the log management component continues to store data in the successive log items of the chunks C₃ to C₅. Arrow B designates the limit between the first log item of the chunk C₆ and the second log item of the chunk C₆, and arrow A designates the limit between the last log item of the chunk C₂ and the first log item of the chunk C₃. Thus, the log management component has copied successively data from the log items of the first two chunks C₁ to C₂ to the non-volatile storage unit while recorded successively other input data in chunks C₃ to C₅.

In the record and drain method, the record method is also referred to as the log producer method and the drain (e.g., transfer) method is also referred to as the log consumer method. During execution of the record method, the following drain conditions are checked as true for launching the drain method. The drain conditions comprise a filling threshold. Thus, the drain conditions may comprise reaching a determined number of filled log items N1i, or reaching a determined number of completely filled chunks Nc. For example, in one embodiment, the drain conditions are true if one chunk is filled with data, meaning if M successive log items are filled with data Nc=1, N1i=M. If the drain conditions are false, the record and drain method stops.

According to the application execution profile, Nc, N1i, N and M integers are chosen at the initialization so as to enable the speed of the drain method to be less than the speed of the record method. These chosen integers also enable the speed of the drain method to be high enough so as to enable the record method to store data on available log items. Thus, no data is lost. The integer p may be set by default (e.g. p may be smaller than 10). The integer p may be also dynamically chosen to enable a record of the more important data in a log item in the least intrusive way.

The log system is a mechanism adapted to record data in log items in a non-intrusive and deterministic way. As seen, the log with its chunks having log items used to store data is reserved, so that real-time constraints are satisfied. As described, a log is a fixed size record containing unsigned integers. This minimizes the CPU time and the amount of memory needed to store a data in a log item. The flexible consumer-producer mechanism provides minimized disruption when data is copied from chunks. The present invention has a deterministic behavior allowing it to be invoked at interrupt level.

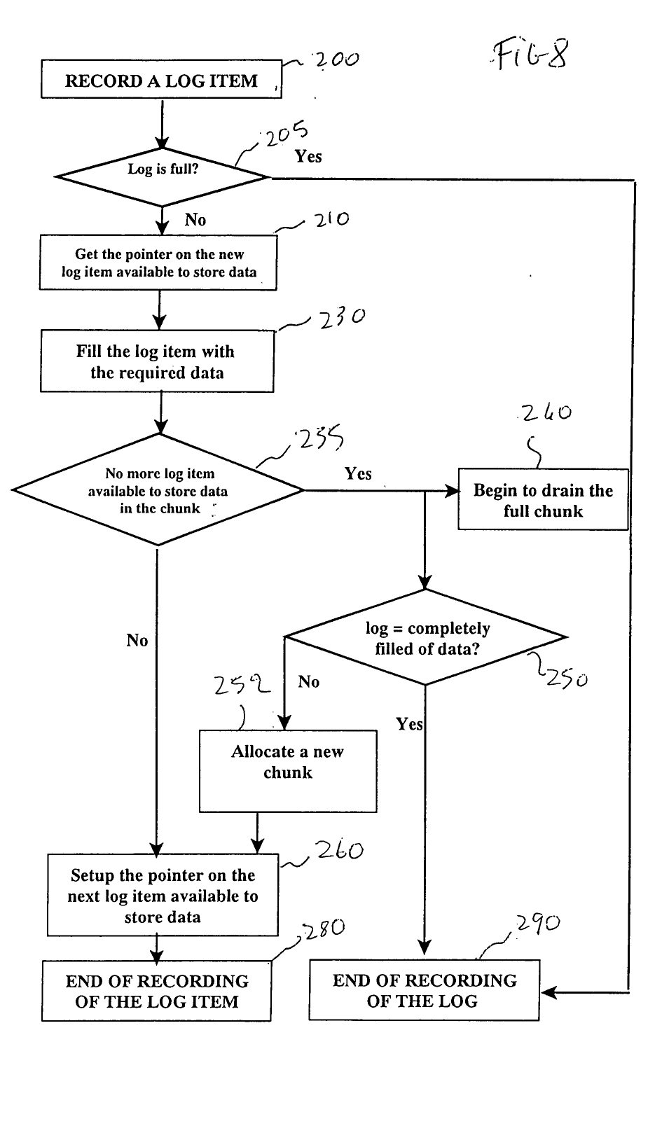

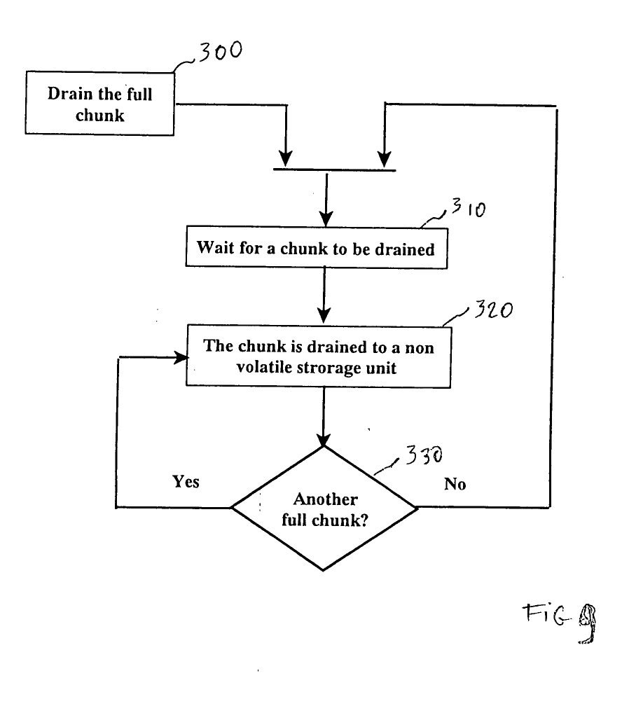

FIG. 7 is a flow chart of a record only method 100 in accordance with an embodiment of the present invention. The record and drain method is illustrated in FIGS. 8 and 9. Specifically, FIG. 8 is a flow chart of the record method 200 of a record and drain method in accordance with an embodiment of the present invention and FIG. 9 is a flow chart of the drain method 300 of a record and drain method in accordance with an embodiment of the present invention.

Although specific steps are disclosed in methods 100, 200 and 300, such steps are exemplary. That is, embodiments of the present invention are well suited to performing various other steps or variations of the steps recited in those flowcharts. It is appreciated that the steps in the flowcharts may be performed in an order different than presented, and that not all of the steps in the flowcharts may be performed. All of, or a portion of, the methods described by methods 100, 200 and 300 can be implemented using computer-readable and computer-executable instructions which reside, for example, in computer-usable media of a computer system or like device.

With reference to FIG. 7, a flow chart of a record only method 100 in accordance with an embodiment of the present invention is described. In method 100, a log may only be divided into log items. Data is received for storage in the log. At step 110, a pointer designates a new log item that is available to store the received data. At step 130, data is stored in the log item such that the log item becomes a filled log item.

At step 135, it is determined whether there are no more log items available to store data in the log. If there are no more log items available to store data in the log, as shown at step 150, the pointer designates the log item having the oldest recorded data. As the log is circular, the first log item of the log has the oldest recorded data and the pointer designates the first log item to store data. Record only method 100 then proceeds to step 180.

Alternately, if at least one log item available to store data is left in the log, as shown at step 160, the pointer designates the next log item available to store data. Record only method 100 then proceeds to step 180. At step 180, record only method 100 ends until another data to record is received and the method restarts at step 110.

With reference to FIG. 8, a flow chart of the record method 200 of a record and drain method in accordance with an embodiment of the present invention is described. In method 200, a log may be divided into chunks and the chunks may be divided into log items. Data is received for storage in the log. At step 205, it is determined whether the log is already full. If the log is full, method 200 proceeds to step 290. Alternatively, if the log is not full, method 200 proceeds to step 210.

At step 210, a pointer designates a new log item that is available to store the received data. At step 230, data is stored in the log item such that the log item becomes a filled log item.

At step 235, it is determined whether there are no more log items available to store data in a particular chunk. If at least one log item remains available to store data in the chunk, as shown at step 260, the pointer designates the next log item available to store data in the chunk.

Alternatively, if no more log items available to store data are left in the log, method 200 proceeds to step 240. At step 240, the completely filled chunk is drained. In one embodiment, drain method 300 of FIG. 9 begins at step 240. In another embodiment, as shown in FIG. 8, the drain method may be launched when more than one filled chunk is completely filled with data.

Concurrently to step 240, at step 250 it is determined whether the entire log is completely filled with data. If the log is entirely filled with data, the record and drain method ends at step 290. Alternatively, if at least one chunk is left, the new chunk is allocated at step 252. At step 260, the pointer designates the next log item available to store data in the new chunk.

After step 260, record method 200 of the record and drain method ends at step 380. If other data are to be stored in the log, record method 200 restarts at step 205.

A flag is a variable that designates which method of the record only method or the record and drain method is to be used. Thus, the record and drain method may be designated with a flag having a “drain” value.

If the record and drain method is designated, the step 240 of FIG. 8 is executed to drain detected completely filled chunk(s). Thus, at step 252, a chunk is available to store data, as this chunk has previously been drained by the transfer (drain) method at step 240 as described above.

With reference to FIG. 9, a flow chart of the drain method 300 of a record and drain method in accordance with an embodiment of the present invention is described. As shown, drain method 300 provides a method to drain chunks. Drain method 300 waits for a chunk to be drained at step 310. When at least one chunk has to be drained, drain method 300 is activated. In one embodiment, completely filled chunks as detected from record method 200 of FIG. 8 are given as parameters. At step 320, a first completely filled chunk is released in the log. According to the parameters, other completely filled chunks may be released at step 330. In the present embodiment, an iteration of steps 320 and 330 may be performed for these other completely filled chunks. Alternatively, drain method 300 returns to step 310 in a waiting state. In one embodiment, drain method 300 is performed in parallel to record method 200 of FIG. 8 in a permanent manner.

Embodiments of the present method are not intrusive, and as such do not modify the behavior of the system or application being debugged. Accordingly, the corresponding system enables a copy (or transfer) of data from a log item to the mass memory during a debugging method in a non-intrusive manner

Embodiments of the present invention are thus described. However, the invention is not limited to the hereinabove described embodiments. Thus, other embodiments of record methods or release methods may be developed according to the invention. Moreover, embodiments in accordance with the present invention are not limited to the application of managing debugging data using a log management component. Any other type of data may be recorded and managed according to the method of the invention. Thus, embodiments of the present invention may be useful in any computer system requiring a non-intrusive method and system to store a whole history of data (e.g. in avionic software).

While the present invention has been described in particular embodiments, it should be appreciated that the present invention should not be construed as limited by such embodiments, but rather construed according to the following claims.

1. A debugging system for receiving data from a debug operation, said debugging system comprising:
a reserved memory comprising a plurality of portions of reserved memory;
a mass memory; and
a log management component for recording received data of a debug operation in at least one portion of said plurality of portions of said reserved memory.

2. The debugging system of claim 1 wherein said log management component is also for copying said data from at least a partially filled portion of said plurality of portions of said reserved memory to said mass memory in response to a drain condition, such that said data is copied to said mass memory in a non-intrusive manner.

3. The debugging system of claim 2 wherein said drain condition comprises a filling threshold.

4. The debugging system of claim 3 wherein said filling threshold comprises a predetermined number of said portions of said reserved memory filled with said data.

5. The debugging system of claim 4 wherein said predetermined number of said portions of said reserved memory is one.

6. The debugging system of claim 2 wherein said log management component is also for executing said copying responsive to a request of user.

7. The debugging system of claim 2 wherein said log management component is adapted to execute said recording and said copying in concurrently.

8. The debugging system of claim 1 wherein a portion of said plurality of portions of said reserved memory comprises a plurality of sub-portions of said reserved memory.

9. The debugging system of claim 8 wherein a sub-portion of memory comprises a number of data values to store at a given time.

10. The debugging system of claim 9 wherein said number of data values is determined by a user so as to enable recording of particular data in a sub-portion of said plurality of sub-portions.

11. The debugging system of claim 10 wherein said number of data values is less than 10.

12. A method of managing data of a debug operation, said method comprising:
reserving a memory comprising a plurality of memory portions;
receiving data of a debug operation;
recording said data in at least one portion of said plurality of memory portions; and
provided said plurality of memory portions comprise said data, designating a particular portion of said plurality of memory portions for recording said data.

13. The method of claim 12 further comprising responsive to a drain condition, copying said data from at least a partially filled portion of said plurality of memory portions to a mass memory.

14. The method of claim 13 wherein said recording said data and said copying said data are performed concurrently to said receiving said data such that successive received data of a debug operation is recorded in a non-intrusive manner.

15. The method of claim 13 wherein said drain condition comprises a filling threshold.

16. The method of claim 15 wherein said filling threshold comprises a predetermined number of said portions of said reserved memory filled with said data.

17. The method of claim 16 wherein the determined number of said portions of said reserved memory is one.

18. The method of claim 12 wherein said copying is adapted to be executed responsive to a request of a user.

19. The method of claim 12 wherein said recording and said copying are performed concurrently.

20. The method of claim 12 wherein a portion of said plurality of portions of said reserved memory comprises a plurality of sub-portions of said reserved memory.

21. The method of claim 20 wherein a sub-portion of memory comprises a number of data values to store at a given time.

22. The method of claim 21 wherein said number of data values is determined by a user so as to enable recording of particular data in a sub-portion of said plurality of sub-portions.

23. The method of claim 22 wherein said number of data values is less than 10.

24. The method of claim 12 wherein said particular portion comprises oldest recorded data.

25. A computer-readable medium having computer-readable program code embodied therein for causing a computer system to perform a method of managing data of a debug operation, said method comprising:
reserving a memory comprising a plurality of memory portions;
receiving data of a debug operation;
recording said data in at least one portion of said plurality of memory portions; and
responsive to drain conditions, copying said data from at least a partially filled portion of said plurality of memory portions to a mass memory.

26. The computer-readable medium of claim 25 further comprising provided said plurality of memory portions comprise said data, designating a particular portion of said plurality of memory portions for recording said data.

27. The computer-readable medium of claim 25 wherein said recording said data and said copying said data are performed concurrently to said receiving said data such that successive received data of a debug operation is recorded in a non-intrusive manner.

28. The computer-readable medium of claim 25 wherein said drain conditions comprise a filling threshold.

29. The computer-readable medium of claim 28 wherein said filling threshold comprises a predetermined number of said portions of said reserved memory filled with said data.

30. The computer-readable medium of claim 29 wherein said determined number of said portions of said reserved memory is one.

31. The computer-readable medium of claim 25 wherein said copying is adapted to be executed responsive to a request of a user.

32. The computer-readable medium of claim 25 wherein said recording and said copying are performed concurrently.

33. The computer-readable medium of claim 25 wherein a portion of said plurality of portions of said reserved memory comprises a plurality of sub-portions of said reserved memory.

34. The computer-readable medium of claim 33 wherein a sub-portion of memory comprises a number of data values to store at a given time.

35. The computer-readable medium of claim 34 wherein said number of data values is determined by a user so as to enable recording of particular data in a sub-portion of said plurality of sub-portions.

36. The computer-readable medium of claim 35 wherein said number of data values is less than 10.

37. The computer-readable medium of claim 26 wherein said particular portion comprises oldest recorded data.
